(19) United States
(12) Patent Application Publication
(10) Pub. No.: US 2008/0314718 A1
(43) Pub. Date: Dec. 25, 2008

(54) Transfer Process and Transfer Device for Individually Packaged Products, Especially Bottles

(76) Inventor: Hubert Asam, Dasing (DE)

Correspondence Address: MCGLEW & TUTTLE, PC, P.O. BOX 9227, SCARBOROUGH STATION, SCARBOROUGH, NY, 10510-9227, US

(21) Appl. No.: 12/097,332

(22) PCT Filed: Dec. 15, 2006
(86) PCT No.: PCT/EP2006/012088

§ 371 Date: Jun. 13, 2008

(30) Foreign Application Priority Data
Dec. 19, 2005 (DE) 20 2005 019 907.9

(51) Int. Cl. B65G 47/28

(52) U.S. Cl. 198/419.3; 198/419.1; 198/426; 53/147; 198/617

(57) ABSTRACT

The invention relates to a transfer method and an apparatus (1) for transferring articles (2) between a line conveyor (25), on which the articles (2) are transported continuously in one or more lines (21), and a stationary or movable tray (7) for accommodating one or more rows (10) of articles. The transfer apparatus (1) has a row-transfer mechanism (11) with a gripping device (12) for one or more rows (10) of articles, and with a manipulator (15). The transfer apparatus (1) also has an accumulating device (27) for temporarily forming and delimiting accumulated groups (28) of articles and gaps (29) in the continuous line (21) on the line conveyor (25) and for independently transporting the group (28) of articles along the line conveyor (25).

### CROSS REFERENCE TO RELATED APPLICATIONS

This application is a United States National Phase application of International Application PCT/EP2006/012088 and claims the benefit of priority under 35 U.S.C. § 119 of German patent application DE 20 2005 019 907.9 filed Dec. 19, 2005, the entire contents of which are incorporated herein by reference.

### FIELD OF THE INVENTION

The present invention pertains to a transfer process and to a transfer device for individually packaged products, especially for bottles

### BACKGROUND OF THE INVENTION

A transfer unit for bottle processing plants, which transfers the bottles being conveyed continuously by a conveyor onto stationary trays, is known from DE 201 08 401 U1. The robot synchronizes itself with the bottle conveyor and grips the row of bottles to be transferred during their conveying. Transfer of bottles from the running line onto trays is possible with this technique, but a reversed transfer operation is not possible. In addition, the transfer unit requires corresponding kinematics for synchronization and moving along piece by piece with the bottles.

### SUMMARY OF THE INVENTION

It is an object of the present invention to show another transfer technique.

The present invention accomplishes this object with the features described in the principal process claim and in the principal device claim. The accumulating technique with the transfer process and with the accumulating device has the advantage that a transfer unit with simple kinematics can be used due to the fact that pulks of individually packaged products or bottles are formed and made ready in such a way that they are ready for transfer. In the simplest case, this may be a conventional portal robot with a cross member and with a gripping device that can be raised and lowered.

The accumulating device itself requires a smaller construction effort and can be arranged next to the line. The accumulating device is, moreover, flexible and can be adjusted to different sizes of product pulks and, moreover, adapted to the velocities at which the bottles are being conveyed in the line. The product pulks can be moved and driven in the accumulating device with independent kinematics and especially at a higher velocity compared to the accumulating conveyor.

The transfer device can be used more universally than prior-art device. It permits a reversed transfer kinematics, in which case individually packaged products, especially bottles, are brought back in a running line and introduced. Suitable gaps can be formed for this purpose in the running line with the accumulating device. In addition, the modes of operation and the kinematics between transfer from the running line and back into the running line can be switched over as desired in the transfer device. As an alternative, the transfer device can be arranged at a switchable bypass of the bottle conveying section.

The transfer device can cooperate with a stationary loading device, in which, e.g., the transfer onto trays takes place, which are made ready stationarily in a loading position. As an alternative, the transfer may take place onto a nonstationary or movable loading arrangement, e.g., onto trays being moved past or onto a line conveyor or the like. The transfer device can be used multifunctionally.

The accumulating device may have any desired and suitable design. With a plurality of holders that can be introduced into the line, the frontmost and optionally also the rearmost bottle are grasped in the bottle pulk, depending on the mode of operation, so that the bottle pulk can be formed over this, delimited against the running line, and it can be moved for independent conveying and positioning in the transfer position relative to the running line conveyor. The holders are designed for this as leaf-shaped or finger-shaped carriers, which can grip between the bottles in the line. A separating device arranged upstream of the accumulating device can ensure a mutual distance between the bottles in the line and better contact conditions. The holders are moved as reversing or circulating holders by means of a conveying device, and the conveying device may have any desired and suitable design. The circulating belt conveyor is an especially simple and easy-to-control embodiment. In particular, it is possible to work with a master axis.

The arrangement of a depositing device for temporarily receiving a row of individually packaged products to be transferred is advantageous for the reversed transfer kinematics with the introduction of individually packaged products, especially bottles, into a running line. This makes it possible to form and transfer complete rows or partial rows and to ensure optimal adaptation to the existing kinematic conditions on the line conveyor and to the gap sizes that can be attained. A conveyor at the depositing device has the advantage that the partial row to be transferred is always made ready at the same location, and this location is kinematically favorable for the gap formation in the running line and for the transfer kinematics. Additional travel axes at the row transfer unit can be done away with as a result if desired.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic top view of a bottle processing plant with a tray storage unit and a transfer device;

FIG. 2 is an enlarged and cut-away top view of an accumulating device in the transfer device;

FIG. 3 is a side view of the accumulating device according to arrow III in FIG. 2;

FIGS. 4 to 8 are schematic top views showing a transfer operation from a row of bottles from the running line onto a tray in a plurality of function steps;

FIGS. 9 to 12 are schematic top views showing a reversed transfer operation from a row of bottles from a tray into a running line in a plurality of function steps; and

FIG. 13 is a schematic top view of another embodiment of a bottle processing plant.

### DESCRIPTION OF THE PREFERRED EMBODIMENTS

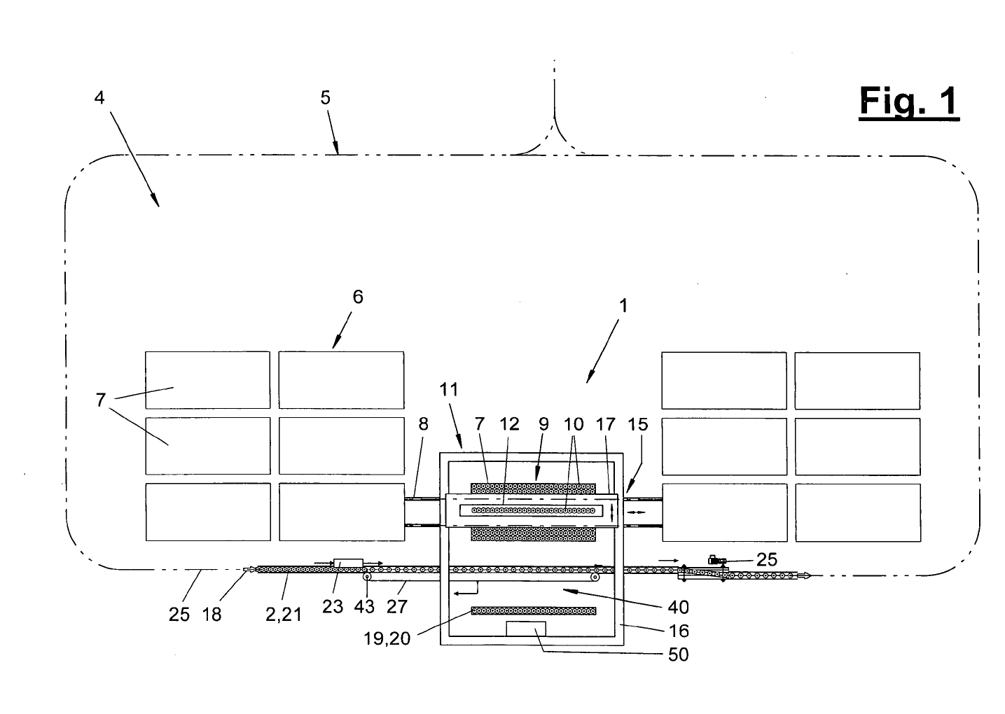

Referring to the drawings in particular, FIG. 1 is a schematic top view of a transfer process and a transfer device (1) for individually packaged products (2), which may be of any desired type. They may be, for example, bottles, especially plastic bottles made of PET or another material. The present invention pertains, in addition, to a bottle processing plant (4), which is equipped with one or more such transfer devices (1).

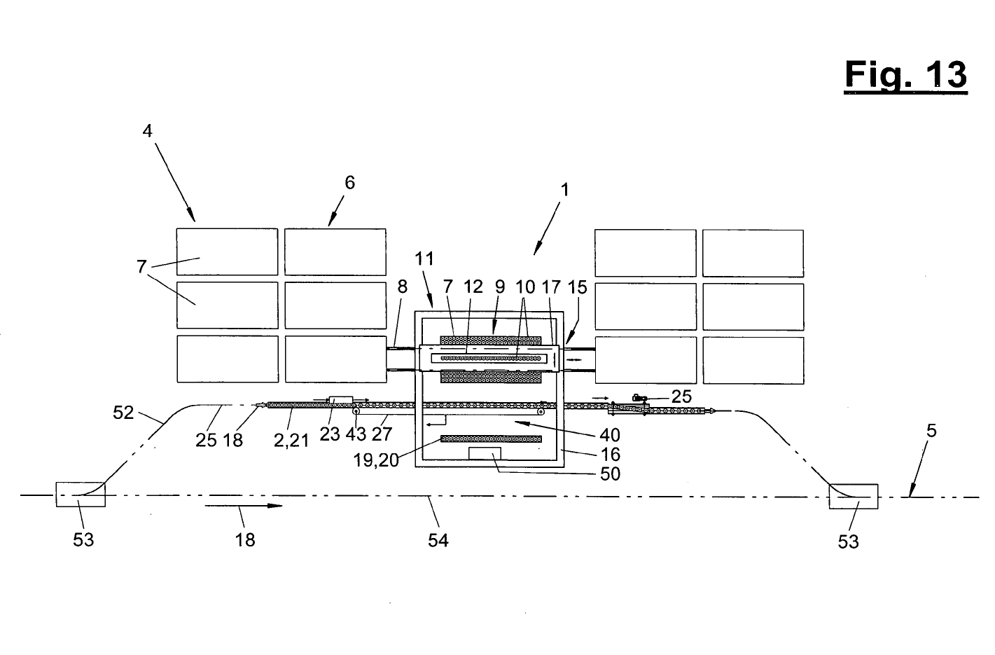

FIGS. 1 and 13 show details of a processing plant (4) with a transfer device (1) for transferring bottles (2) in a schematic top view. The kinematics and design embodiments of the transfer device (1), which are explained below, are related to the transfer of bottles (2). The components of the device are correspondingly modified and adapted for the transfer of other types of individually packaged products. The following explanations apply, with corresponding adaptations, to all types of individually packaged products (2).

The bottles (2) are conveyed continuously on a line conveyor (25) in a line (21) on an open or closed conveying path (5). As an alternative, a plurality of parallel line conveyors (25) with a plurality of lines (21) or one line conveyor (25) with a plurality of parallel lines (21) may be present. The line conveyor (25) or line conveyors (25) is/are designed, e.g., as a belt conveyor, on which the bottles (2) are being conveyed in the upright position and are secured during conveying with a suitable guide (26) against falling over laterally. As an alternative to belt conveyors, it is possible to use any other types of preferably continuously operating conveyors as desired, which convey bottles (2) in such a position in which they can be gripped. In the embodiment being shown, the line conveyor (25) extends through the transfer device (1) and can have a shunt at the end of the path for diverting the bottles (2) onto another conveyor.

The bottles (2) are conveyed in the bottle processing plant (4) in an, e.g., circular conveying path (5) with suitable conveying means and they can be deflected via diverters into other areas of the plant, e.g., to a filling means, a palletizing device or the like. Conversely, it is also possible to introduce bottles (2) into the conveying path (5). The line conveyor (25) may be part of this conveying path (5).

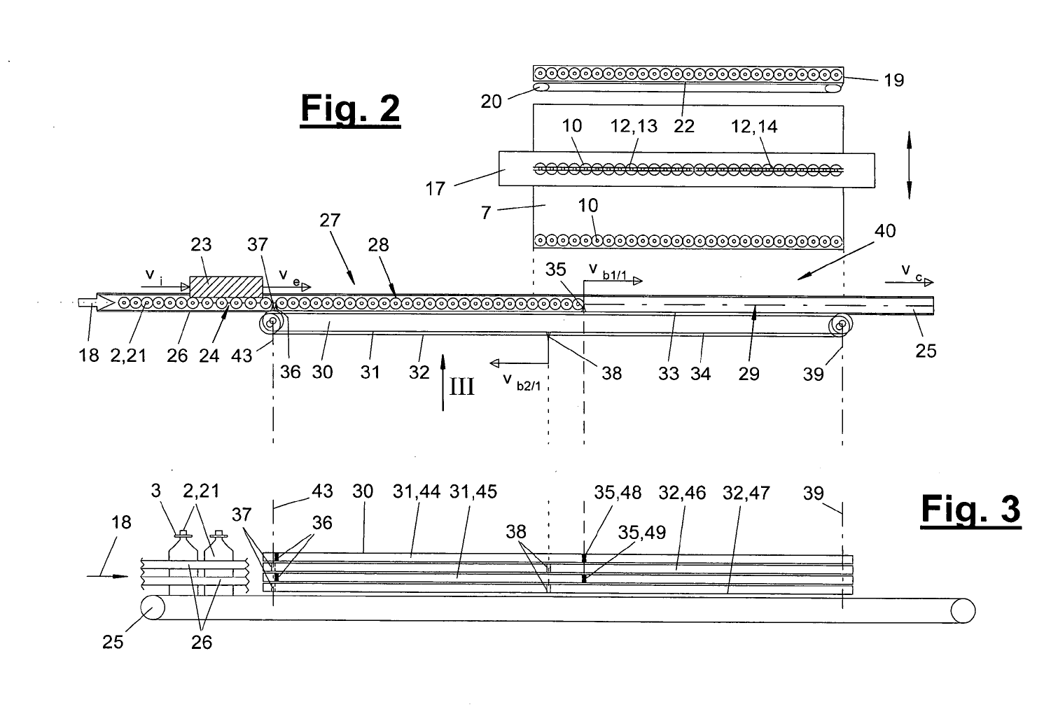

The bottles (2) are conveyed in the line (21), e.g., spaced closely to one another with mutual contact and in a row one behind the other in a constant, interruption-free conveying motion. The line conveyor (25) may have, at one or more locations, a separating device (23), which has a design similar to that, e.g., in DE 201 08 401 U1, and has a rotating driven screw arranged along the direction of conveying (18) with a pitch increasing in the direction of conveying to form axial spaces (24) between the bottles (2). FIG. 2 shows this space-forming function.

At least one transfer device (1), with which bottles (2) can be taken from the running line (21) in the form of rows of bottles (10) and transferred onto a tray (7) standing ready in a loading position (9), is present in the bottle processing plant (4). As an alternative, the transfer device (1) makes possible a reversed transfer operation, in which bottles (2) in complete rows of bottles (10) or in partial rows (41, 42) are transferred from a tray (7) into the running line (21) and introduced there.

As is illustrated in FIG. 1, the bottle conveyor (25) and the line (21) or the conveying path (5) can pass through the transfer device (1), so that the transfer operations always take place from the running line (21) or into same.

FIG. 13 shows a variant, in which, e.g., an open conveying path (5) leads from a bottle producer (not shown), e.g., a blowing machine for producing plastic bottles, to a filling plant (not shown). The transfer device (1) is connected in this exemplary embodiment via a bypass or a secondary path (52) to the main path (54) via one or more switchable diverters (53). In normal operation, the bottles (2) are moving on the main path (54) in the direction of conveying (18) and past the transfer device (1). When bottles (2) are to be removed from or introduced into the line (21), the line (21) is diverted onto the bypass (52) by actuating a diverter (53) and sent through the transfer device (1) and subsequently back again to the main path (54). The gripping device (1) may have the same design in the two exemplary embodiments according to FIGS. 1 and 13.

The transfer device (1) has a row transfer unit (11) with a gripping device (12) for at least one row of bottles (10). When the row transfer device (11) handles an individual line (21), the gripping device (12) grips an individual row of bottles (10). If a plurality of parallel lines (21) are handled, the gripping device (12) can correspondingly grip a plurality of rows of bottles (10).

The row transfer unit (11) has a manipulator (15) for moving the gripping device (12). In the embodiment being shown, this is a portal robot (15) with one or more translatory axes, which has, e.g., a portal-like frame (16) with an elevated cross member (17) displaceable thereon at right angles to the direction of conveying (18), with the gripping device (12) arranged hanging thereon. The gripping device (12) may be of any suitable type and it grips the bottles (2) at a suitable point, especially on a collar (3) in the head area. The gripping device (12) may be divided according to FIG. 2 over its length into two or more individually controllable gripper areas (13, 14), with which partial rows (41, 42) of a row of bottles (10) can be gripped and transferred. The gripping device (12) is designed in the preferred embodiment as a row gripper, which grips the bottles lined up with gripping jaws or the like. As an alternative, it is possible to use other gripping elements, such as suction cups or the like.

The transfer device (1) has, furthermore, an accumulating device (27), which is associated with the line conveyor (25) and which is used to temporarily form and delimit accumulated bottle pulks (28) and gaps (29) in the running line (21). In addition, the bottle pulk (28) formed can be conveyed with the accumulating device (27) along the line conveyor (25) at a velocity different from the velocity at which the line conveyor is running. The accumulating device (27) can grip, in particular, the bottle pulk (28) at the two ends, transport it independently as a pulk and drive it at varying velocities, which may be at times lower and at times higher than the line conveyor velocity. The bottles (2) in the bottle pulk (28) are moved in a dragging along manner over the line conveyor (25).

The accumulating device (27) is arranged, e.g., next to the line conveyor (25) and in the area of the row transfer unit (11). This has advantages for the reliable gripping and guiding of the bottles (2) in case of varying velocities of conveying. There also is more space for gripping over the height of the bottle, and, moreover, a plurality of gripping points offset in height are available. The accumulating device (27) may be arranged, as an alternative, at another location, e.g., under the line conveyor (25).

The accumulating device (27) extends in the direction of conveying (18) at least up to the rear end of the tray (7). The accumulating device (27) extends in the opposite direction beyond the row transfer unit (11) and thus has a greater length than the row of bottles (10) to be transferred. One of the separating devices (23) described above is arranged in front of the accumulating device (27) in the direction of conveying (18).

The accumulating device (27) has a plurality of holders (35, 36, 37, 38), which can be introduced into the line (21), grip between the bottles (2) in the running line, and are movable by means of a conveying device (30) in the direction of conveying (18) in a reversing or circulating pattern. The holders (35, 36, 37, 38) preferably grip into the spaces (26) between the bottles (2). The conveying device (30) can be driven at variable velocities and also stop.

The conveying device (30) and the holders (35, 36, 37, 38) may have any desired and suitable design. In the exemplary embodiment being shown, the conveying device (30) is designed as a laterally circulating belt conveyor with vertical deflection axes (39, 43), of which the deflection axis (43) located in the front in the direction of conveying (18) is a master axis, which is connected to the control (50) of the transfer device (1) in terms of signal technology and via the motions of which the subsequent functions are controlled.

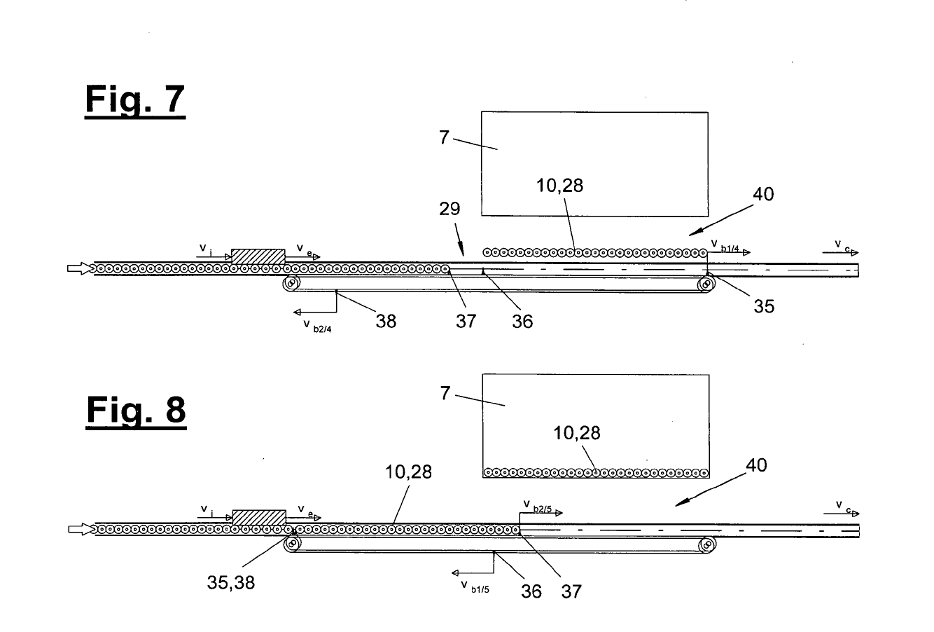

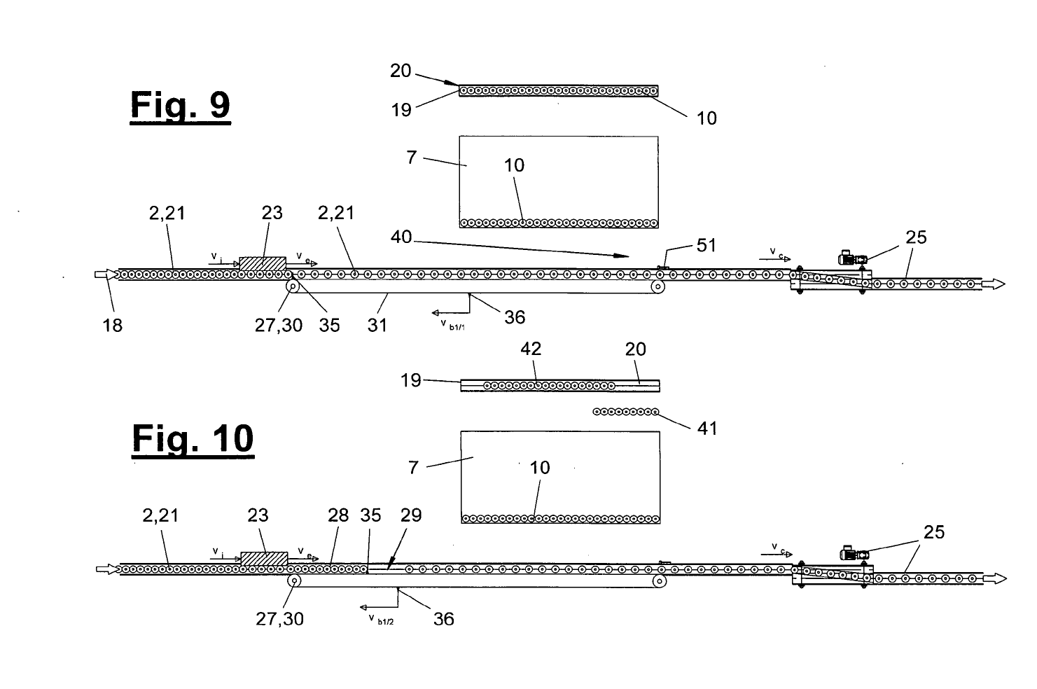

In the exemplary embodiments shown in FIGS. 2 through 8, the belt conveyor has, e.g., two circulating belts or belt groups (31, 32), which are arranged one on top of another in the axial direction and which are guided and driven separately from each other and which can move at variable velocities from each other. In the variant according to FIGS. 9 through 12, the belt conveyor may have a single circulating belt or a single circulating group (31), and a stopper (51) may be additionally present at the line conveyor (25).

FIG. 3 illustrates the embodiment of the first conveyor variant with two belt groups (31, 32). Both belt groups (31, 32) comprise two parallel partial belts (44, 45) and (46, 47) each, which are arranged one on top of another in the axial direction. The partial belts (44, 45) and (46, 47) belonging to one belt group (31, 32) are driven and moved together. The drives are connected to the control (50) and not shown for the sake of clarity. The partial belts (44, 45) and (46, 47) are arranged one on top of another in such a way that the groups cross over each other and, e.g., in FIG. 3, the partial belts (44, 45) arranged in the first and third places of the four partial belts arranged one on top of another when viewed from top to bottom belong to the first belt group (31). The partial belt (46) and the lowermost partial belt (47) located in between belong to the second belt group (32).

A plurality of holders (35, 36, 37, 38) are arranged rigidly and optionally adjustably at the circulating belts or bent groups (31, 32). For example, two holders (35, 36) and (37, 38) each are arranged at a distance in the direction of circulation at their circulating belt (31, 32) which distance corresponds to the length of a bottle pulk (28) and of the row of bottles (10) formed therefrom. In the pulk and in the row of bottles (10), bottles (2) stand close to each other and preferably in mutual contact with one another one behind the other in the direction of conveying (18). The holders (35, 36) and (37, 38) are designed as narrow, finger- or leaf-shaped carriers, which project laterally from the circulating belt (31, 32) and which can grip between the bottles (2) in the running line (21) and especially into the distances (24) while running around the axis (43).

The carrying run (33) of the circulating belts or belt groups (31, 32) is arranged in parallel to and in the immediate vicinity of the running line (21). The loose side (34) is located at a laterally spaced location. After running around the axis (43) that is the front axis in the direction of conveying (18), the outwardly projecting holders (35, 36, 37, 38) enter the running path of the line (21) in a pivoting motion. When running around the rear axis (39), they will again become disengaged from the line (21). The thickness of the carriers is coordinated with the contour of the bottles (2) and the spaces (24) possibly formed. In the belt groups (31, 32) with two or more partial belts (44, 45, 46, 47) each, the carriers (35, 36, 37, 38) are divided into two or more carrier tabs (48, 49) each, which are arranged one on top of another in the axial direction. Due to the fact that the partial belts (44, 45, 46, 47) are arranged such that the groups cross over each other, the carrier tabs (48, 49) can overtake each other group by group and move relative to one another. In addition, two carriers or their four carrier tabs (48, 49) can grip together at one location between the bottles (2) in the line (21), as this is shown, e.g., at the left-hand axis (43) in FIG. 2. The belt groups (31, 32) are shown in the drawings laterally offset in relation to one another in the top views for the sake of clarity.

At its rear end of the row transfer unit, the accumulating device (27) has a transfer zone (40), which lies at the same level as and laterally next to the tray (7). In the transfer zone (40), the bottle pulk (28) intended for transfer can be positioned in a temporarily nonmoving manner for transfer to the row transfer unit (11). A gap (29) can likewise be formed in the running line (21) for inserting a row of bottles (10) or a partial row (41, 42).

As is illustrated in FIGS. 1, 2 and 13, a depositing device (19) for at least one row of bottles (10) may be arranged laterally next to the tray (7) or the loading position (9) and preferably in the direction of conveying (18) at the same level. The depositing device (19) has a lateral guide (22) for the bottles (2) lined up in a row next to each other. It can, moreover, have a bottle conveyor (20), which is designed, e.g., as a circulating belt, on which the bottles (10) can likewise be conveyed upright in the direction of conveying (18). A stop, which stops and piles up the bottles being conveyed, is present at the guide (22) at the end that is the rear end on the conveying side.

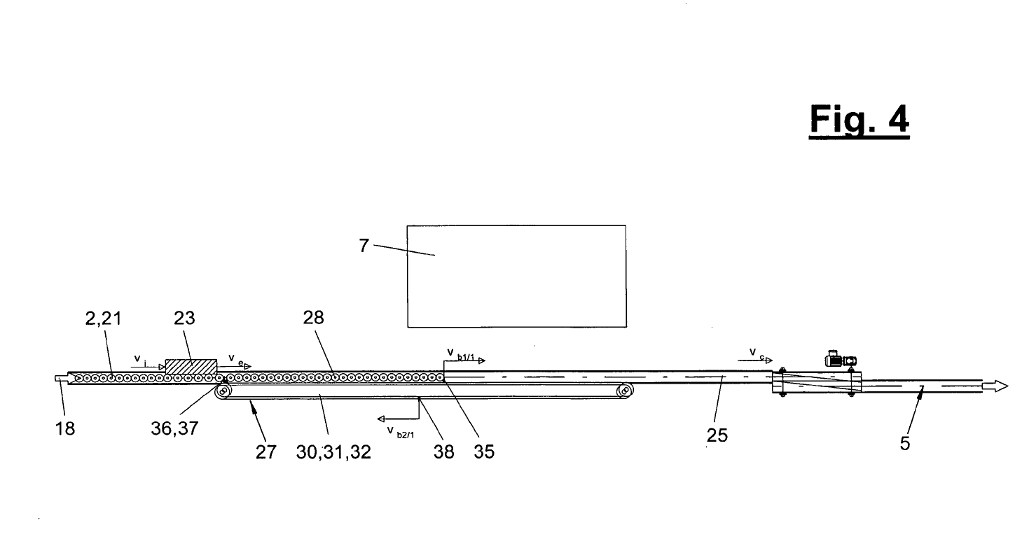

The transfer functions will be explained below on the basis of FIGS. 4 through 8 and 9 through 12.

In the embodiment according to FIGS. 4 through 8, rows of bottles (10) shall be transferred from the running line (21) onto the tray (7) standing ready. A row of bottles (10) is, e.g., as long here as the receiving area on the tray (7), the tray (7) being able to receive a plurality of rows of bottles next to each other. As an alternative, the length of a row of bottles and the length of a tray may also vary. The bottle pulk (28) piled up corresponds to the length of a row of bottles (10) in the embodiment being shown. There may alternatively be differences in length in this case as well.

As is illustrated in FIG. 4, the front holder (35) or its carrier tabs (48, 49) of one circulating belt or belt group (31) grip into the area in front of the first bottle (2) in the pulk (28) to be piled up. The holder (35) is now moving with its belt group (31) in the direction of conveying (18) more slowly than the line (21), so that the spaces (24) formed at first by the screw (23) between the bottles are again eliminated and the bottles are accumulated in the pulk (28). As soon as the bottle pulk (28) has reached the intended length, the rear holder (36) engages and extends behind the last bottle (2) in the pulk (28). FIG. 4 shows this arrangement.

At the same time, the first holder (37) of the second belt group (32) can grip into the area in front of the bottle (2) following next in the arriving line (21).

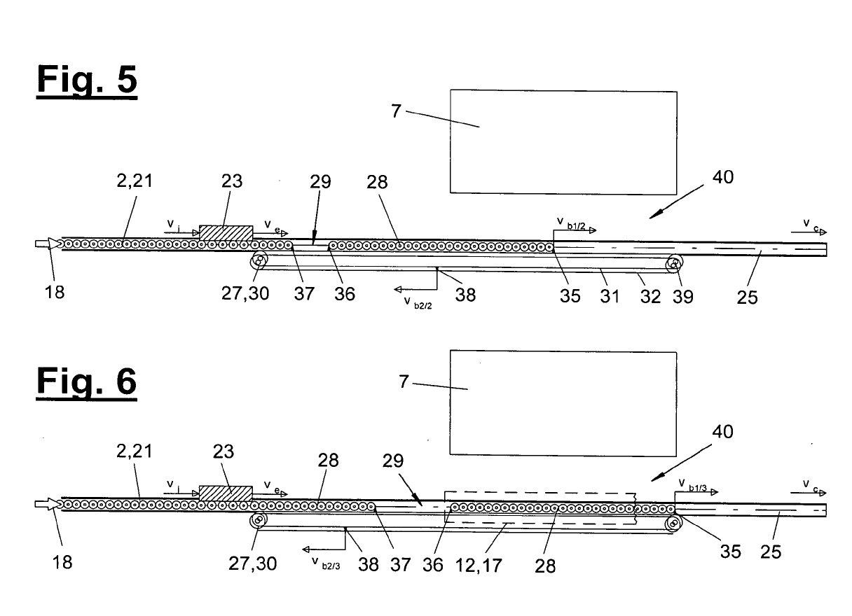

The bottle pulk (28) formed and delimited now between the holders (35, 36) can now be moved forward by an accelerated conveying motion of the belt group (31) in the direction of conveying (18), and the first holder (37) of the other belt group (32) running more slowly and begins to pile up the next bottle pulk (28). A gap (29) is formed between the two bottle pulks and the holders (36, 37) due to the different conveying velocities. FIG. 5 shows this arrangement.

The first bottle pulk (28) formed is conveyed with the acceleration mentioned up into the transfer zone (40) and stopped here by a stop of the belt group (31), while the bottle conveyor (25) under the bottle pulk (28) continues to run. The bottle pulk (28) or the row of bottles (10) can be gripped in this temporarily nonmoving position by the row transfer unit (11) with the cross member (17) positioned above the transfer zone (40) and gripped by the lowered gripping device (12). The row of bottles (10) is lifted off from the bottle conveyor (25) by a relative stroke, e.g., an upward stroke, positioned by a displacement of the cross member (17) above the intended loading site on the tray (7) and lowered for releasing the bottle on the tray (7). The row transfer unit (11) then returns into the transfer zone (40) for picking up the next bottle pulk (28).

As an alternative, the relative stroke may be different. It may be, e.g., a side stroke, with which the row of bottles (10) is pushed off laterally from the bottle conveyor (25).

Due to the formation of the gaps (29) between the bottle pulks (28), there is enough time to grip and lift off, push off or move in another way the stopped bottle pulk (28). The length of the accumulating device (27) is selected to be such that the desired kinematic functions can be attained.

FIGS. 6 through 8 illustrate the above-mentioned transfer function of the row of bottles (10) onto the tray (7) and show, in addition, the entry of the next bottle pulk (28) being moved in an accelerated manner into the transfer zone (40).

When the bottle pulk (28) is unloaded from the belt group (31), the first holder (35) is moved forward at such an increased velocity and synchronized with the rear holder (38) of the second belt group (32) such that the two will together engage the line (21) after running around the axis (43). The above-described cycle will then begin anew.

FIGS. 9 through 12 illustrate the returning of rows of bottles (10) from the tray (7) into the running line (21). The rows of bottles (10) can be transferred as complete rows or as partial rows (41, 42). In a variation of the above-described construction, the transport device (30) may have, moreover, only one circulating belt (31) with two holders (35, 36) and, in addition, the stopper (51) at the end of the transfer zone (40).

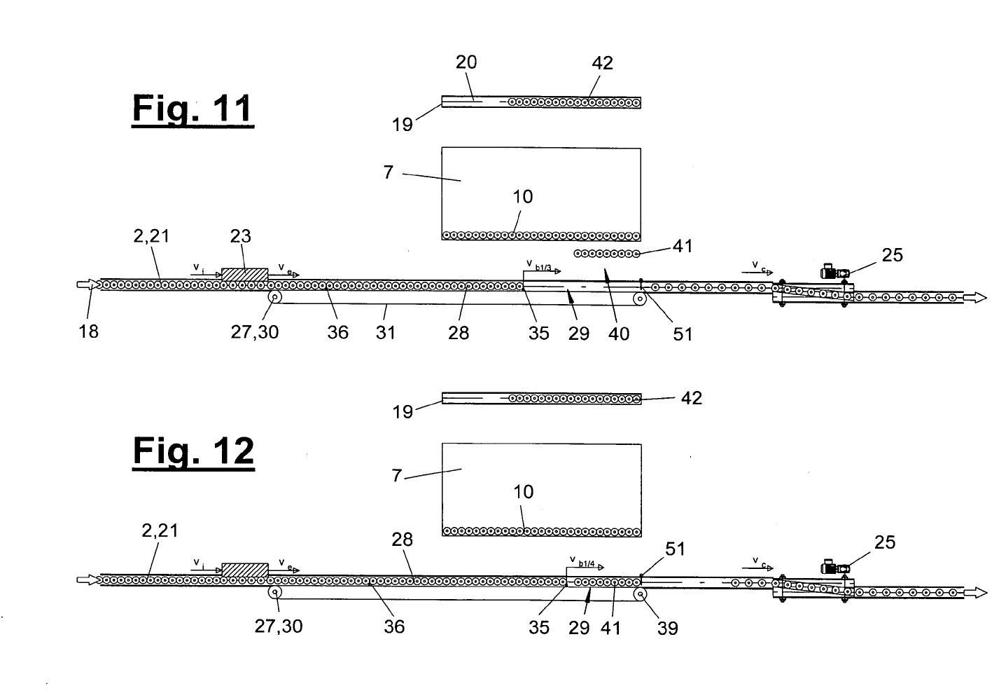

FIG. 9 illustrates the situation in which the row transfer unit (11) (not shown) has at first transferred a row of bottles (10) onto the depositing device (19) and is now ready to grip the complete row of bottles (10) or a plurality of partial rows (41, 42) from the deposited row of bottles (10) and to insert them into gaps (29) in the line (21), which are formed by the accumulating device (27). FIG. 9 illustrates the beginning of the pile formation, wherein the stopper (51) is open and the first holder (35) grips between two bottles (2) in the line (21). Holder (35) now moves with the circulating belt (31) in the direction of delivery (18) more slowly than the line conveyor (25) and forms a piled-up bottle pulk (28), and a gap (29) is formed, in addition, in relation to the bottle (2) moving away at the velocity of the line. FIG. 10 shows this intermediate step. The gap (29) increases over the further path and arrives in the transfer zone (40). The gripping device (12) has gripped a partial row (41) with the gripper area (14) that is located in front in the direction of conveying (18) and can be controlled individually (cE FIG. 2) and moves this according to FIGS. 11 and 12 to the conveying path of the line (21) and deposits same in the area of the gap (29) on the line conveyor (25). Stopper (51), which is pivoted in, holds the bottles and the partial row (41) during deposition and secures them against falling over. Stopper (51) opens after release of the partial row (41) and in time before arrival of the piled-up bottle pulk (28), so that the partial row (41) can be conveyed away with the line (21). Both holders (35, 36) will subsequently become disengaged from the line (21) and release the bottle pulk (28) created temporarily for forming a gap, so that the bottle pulk (28) can also run off in the direction of conveying (18). The first holder (35) then returns into the starting position according to FIG. 9 by an optionally accelerated circulating motion to form a new bottle pulk (28) and a new gap (29). The operation described is repeated; the second partial row (42) is gripped by the depositing device (19) and introduced into the line (21). The bottle conveyor (20) has now moved the partial row (42) in the direction of conveying (18) in the forward direction and in the stop position, so that the next partial row can be gripped and transferred with the front gripper area (14). This is correlated with the position of the gap (29) in the area of the transfer zone (40).

In an embodiment according to FIGS. 9 through 12, an accumulating device (27) with the two circulating belts or belt groups (31, 32), which was described at the beginning, may also be used for this introduction of rows of bottles (10) or partial rows (41, 42). The belt stopper (51) may be eliminated in this case. Sufficiently large gaps can be created for introducing partial rows (41) between the bottle pulks (28) formed on each belt due to the separately drivable belt groups (31, 32) and the holders (35, 36) and (37, 38) thereof, and a partial row (41) of a length corresponding to the gap formation can be inserted after each bottle pulk (28). The respective rear holder (36, 38) of the belt groups (31, 32) can temporarily stop after release and run-off of its bottle pulk (28) and assume the function of the stopper (51) as a stop for securing the introduced partial row (41, 42) against falling over. In addition, it is possible that the respective rear holder (36, 38) will be moved on at increasing velocity after deposition of the partial row (41, 42), and the deposited partial row (41, 42) will be gradually accelerated to the line conveyor velocity. Synchronization of the two velocities can thus be achieved before the holder (36, 38) reaches the rear axis (39) and releases the partial row (41, 42). The gradual acceleration and the synchronization represent an additional securing against the bottles (2) falling over.

Various variants of the embodiments shown and described are possible. The transport device (30) may be, instead of the circulating belts (31, 32), a linear or reversingly moving drive, e.g., a cylinder, which moves forward and backward in the direction of conveying (18). The holders may be designed in this case as holders pivotable in a controlled manner about the axis of the piston rod, and they grip into the line (21). Such a linear cylinder drive may be arranged on one side or on both sides of the line (21) and the conveying path thereof, and the same functions can be achieved in case of double-sided arrangement as in case of the two circulating belts or belt groups (31, 32). In another variant, any other desired embodiment of the transport device and of the holders is possible.

In the embodiment according to FIG. 1, the trays (7) are arranged in one or more storage units or buffers (6) next to the transfer device (1) and can be brought into the loading position (9) and removed from this position by means of a conveyor (8). Depending on the transfer kinetics, empty and full trays (7) can be replaced.

In a variant of this, the trays can be stopped in the loading position (9) only briefly, e.g., when a tray (7) can be filled or emptied with one or more rows of bottles (10) in a transfer operation. Furthermore, it is possible to move the trays (7) during the transfer operation if the row transfer unit (11) has a corresponding additional axis for the joint temporary motion. In addition, it is possible to deposit the rows of bottles (10) during transfer directly on a conveyor rather than on a trough-like tray or another receiving device. Transfer of bottles between two line conveyors of identical or similar design can take place with the above-described technique with one or more lines, an accumulating device of the above-described type being assigned to both line conveyors.

The embodiment of the row transfer unit (11) and other components of the transfer device (1) can be varied as well. The manipulator (15) may be designed, in particular, as an articulated-arm robot.

While specific embodiments of the invention have been shown and described in detail to illustrate the application of the principles of the invention, it will be understood that the invention may be embodied otherwise without departing from such principles.

1. A transfer device for individually packaged products, the device comprising:
a transfer means for moving the individually packaged products between at least one line conveyor, on which the individually packaged products are conveyed continuously in one or more lines, and a stationary or movable loading device for receiving one or more rows of individually packaged products, said transfer means comprising an accumulating device, a row transfer unit with a gripping means for gripping at least one said row of individually packaged products and a manipulator, said accumulating device temporarily forming groups of individually packaged products from said one or more lines of accumulated individually packaged products on said line conveyor, said accumulated device forming gaps in said one or more lines of individually packaged products on said line conveyor, said accumulating device independently transporting said groups of individually packaged products along said line conveyor.

2. A transfer device in accordance with claim 1, wherein said accumulating device is arranged adjacent to said line conveyor and in an area of said row transfer unit, wherein said accumulating device extends in a direction opposite a conveying direction of the individually packaged products such that a portion of said accumulating device extends to a position beyond said row transfer unit.

3. A transfer device in accordance with claim 1, wherein a portion of said accumulating device defines a transfer zone in an area of said row transfer unit, and a group of individually packaged products is positioned in said transfer zone such that said group of individually packaged products do not move temporarily when in said transfer zone or said accumulating device retains said individually packaged products such that one of said gaps is formed in said one or more lines of individually packaged products in said transfer zone whereby a row of individually packaged products or a partial row of individually packaged products is inserted in said one of said gaps when one of said gaps is formed in said one or more lines of individually packaged products via said accumulating device.

4. A transfer device in accordance with claim 1, wherein said line conveyor has a separating device arranged in front of said accumulating device in with respect to a conveying direction of said individually packaged products, said separating device engaging one or more said individually packaged products in said running line such that one individually packaged product is located at a spaced location from another individually packaged product.

5. A transfer device in accordance with claim 4, wherein said separating device comprises a screw, said screw separating one individually packaged product from another individually packaged product.

6. A transfer device in accordance with claim 1, wherein said accumulating device has a plurality of holders movable in a conveying direction of the individually packaged products, said holders gripping one or more of a first individually packaged product and a last individually packaged product in one of said groups of products.

7. A transfer device in accordance with claim 1, wherein said accumulating device has a transport means for moving said holders at various velocities.

8. A transfer device in accordance with claim 7, said transport means comprises a belt conveyor, said belt conveyor circulating laterally with two circulating belts or belt groups arranged one on top of another.

9. A transfer device in accordance with claim 8, wherein said circulating belts or belt groups are driven separately and at variable velocities relative to one another.

10. A transfer device in accordance with claim 6, wherein said two holders are arranged at said circulating belts or belts groups such that one holder is located at a spaced distance from another holder, said spaced distance corresponding to a length of one of the groups of said individually packaged products.

11. A transfer device in accordance with claim 10, wherein said holders comprise narrow, finger- or leaf-shaped carriers extending laterally from said circulating belt.

12. A transfer device in accordance with claim 11, wherein each of said belt groups are divided into two or more partial belts and each of said carriers are divided into two or more carrier tabs.

13. A transfer device in accordance with claim 12, wherein said partial belts are arranged one on top of another such that said partial belts cross each other in groups.

14. A transfer device in accordance with claim 1, wherein said transfer means has a depositing means with a conveyor for temporarily receiving a row of individually packaged products.

15. A transfer device in accordance with claim 3, wherein said gripping means of said row transfer unit has a plurality of separately controllable gripper areas for gripping at least one said partial row of individual packaged products.

16. A transfer device in accordance with claim 1, wherein said transfer means has a control with a master axis associated with said accumulating device.

17. A processing plant for individually packaged products, the processing plant comprising:
a plurality of individually packaged products;
a conveyor receiving said individually packaged products such that said individually packaged products are conveyed continuously in one or more lines;
a loading device receiving one or more rows of individually packaged products;
a transfer means for moving one or more rows of individually packaged products from said one or more lines of individually packaged products on said conveyor to said loading device, said transfer means comprising an accumulating device, a row transfer unit with a gripping means for gripping at least one of said rows of individually packaged products and a manipulator, said accumulating device engaging said one or more lines of individually packaged products such that said accumulating device forms one or more of said one or more rows of individually packaged products and gaps in said one or more lines of individually packaged products on said line conveyor, said accumulating device transporting said rows of individually packaged products along said conveyor.

18. A processing plant in accordance with claim 17, wherein said accumulating device has a plurality of holders movable in a conveying direction of the individually packaged products, said holders gripping one or more of a first individually packaged product and a last individually packaged product of said one or more said rows of individually packaged products, said two holders being arranged at said circulating belts or belts groups such that one holder is located at a spaced distance from another holder, said spaced distance corresponding to a length of one of the rows of said individually packaged products, said accumulating device having a conveyor belt for moving said holders at a plurality of velocities, said conveyor belt being perpendicular to said conveyor.

19. A processing plant in accordance with claim 17, further comprising a storage unit for storing one or more trays, said storage unit being connected with a loading position in an area of said transfer means via a tray conveyor.

20. A process for transferring individually packaged products, the process comprising:
continuously conveying individually packaged products on a line conveyor such that said individually packaged products are conveyed in one or more lines;
providing a loading device for receiving one or more rows of individually packaged products;
providing a transfer means comprising an accumulating device, a row transfer unit with a gripping means for gripping at least one said row of individually packaged products and a manipulator;
separating said one or more lines of individually packaged products with said accumulating device to form said one or more rows of individually packaged products and forming gaps in said running line with said accumulating device;
independently conveying said one or more rows of individually packaged products along said conveyor with said accumulating device; and
transferring said one or more rows of individually packaged products from said conveyor to said loading device with said transferring means.
